(19) United States
(12) Patent Application Publication
(10) Pub. No.: US 2004/0068734 A1
(43) Pub. Date: Apr. 8, 2004

(54) Software license isolation layer

(75) Inventors: Barry Bond, Maple Valley, WA (US); Geoffrey B. Shilling, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/265,819

(22) Filed: Oct. 7, 2002

(51) Int. Cl. G06F 9/00

(52) U.S. Cl. 719/328

(57) ABSTRACT

A license isolation layer isolates application source code from an incompatible target platform license, while allowing the application source code to indirectly use services provided by target platform licensed software. The license isolation layer may include an interface definition and an implementation of the interface definition. The application source code binds to the implementation of the license isolation layer interface definition. The compiled application object file may use services provided by the implementation of the license isolation layer interface. The implementation of the license isolation layer interface may use services provided by target platform licensed software thereby isolating the application source code from applicability of the target platform license.

### FIELD OF THE INVENTION

The invention relates to software licenses and more particularly to isolating source code from a target platform software license that is incompatible with the source code's license.

### BACKGROUND OF THE INVENTION

Developing software for a computing platform is greatly simplified when the software being developed can use services provided by the computing platform. As used in this document, the term platform includes, but is not limited to, a software operating system and/or open computer-system hardware, which a third party could write software for. Software licensing issues may arise however, if the target platform and the software being developed have incompatible software licenses.

There are several types of software licenses, involving both source code and object code. Some examples of commonly used source code licenses include Berkeley Software Design (BSD), GNU Public License (GPL), and Sun Community Software (SCSL). In addition, various companies make their source or object code available under a wide variety of licenses. Some source licenses are commonly referred to as “open” source licenses since they typically allow further modification and use of the source with a variety of restrictions and constraints. Some open source licenses, such as the GPL, impose constraints on the restrictions that can be placed upon GPL licensed code. The GPL is intended to guarantee developers' freedom to share and change GPL licensed software by, among other things, requiring software developers to disclose their source code for GPL-licensed software. According to the GPL license, any code released under the GPL must remain under the GPL. This has the effect of requiring any modifications to code released under the GPL and any code “mixed” with the GPL to all be released under the GPL. To legally include GPL code in a program, developers must release their program—and disclose their source code—under the GPL.

However, there may be times when a developer desires to combine their code with code released under an open source license without subjecting their code to the same license. Various licenses take various approaches to this situation. For example, the BSD license typically allows such a situation (e.g. it does not require that code combined with BSD licensed code must be released under any specific type of license). The GPL, on the other hand, takes the opposite approach and, at least on its face, purports to preclude such a scenario. As an alternative to the GPL, the Free Software Foundation issued the GNU Lesser General Public License (LGPL), which contains provisions that attempt to specify whether software that uses or is combined with LGPL-licensed software is subject to the LGPL. However, for a variety of reasons, it can be difficult to determine when code that uses or is combined with LGPL-licensed code must be released under the LGPL. What is needed is a mechanism that can be used to develop code that can clearly be released free of any license restrictions of related code.

### BRIEF SUMMARY OF THE INVENTION

The present invention addresses situations where it can be difficult to determine which license terms might apply to developed software code that is to be combined with other software code released under licenses that purport to restrict the terms under which other software can be released. The invention uses a “license isolation layer” of software which insolates one group of code from the license terms of another group of code. The invention also describes a software development method and related technology and methods to achieve “license isolation” between two groups of code. This summary should not be used to interpret the specific scope of the invention, which is set by the claims appended herewith, nor to identify significant elements which must accompany any embodiment of the invention. This summary is provided for the sole purpose of setting out a simple summary of one possible embodiment of the invention. The full scope and description of the invention should be taken from the appended claims and detailed description.

A license isolation layer isolates one group of code (application code) from underlying code licensed according to terms that purport to restrict how application code must be licensed. A license isolation layer developed according to the present invention is developed according to specific guidelines, set based on the terms of the license of the underlying code. The license isolation layer typically includes a license isolation layer interface definition that is outside of the scope of the underlying code license. The license isolation layer may also include an implementation of the license isolation layer interface definition that makes use of the underlying code. The application source code may use the license isolation layer interface definition and bind to the implementation of the license isolation layer interface definition without binding to target platform licensed software components. In this way, the license isolation layer can prevent the application source code from being subject to the target platform software license.

### BRIEF DESCRIPTION OF THE DRAWINGS

FIG. 1 depicts a prior art scenario for porting an application program to run on a target platform.

FIG. 2 shows a scenario similar to FIG. 1 that includes an inventive license isolation layer interface definition and an implementation of the interface definition.

FIG. 3 is similar to FIG. 2 with the license isolation layer header acting as a buffer between the application source code and the license isolation layer library, which may be subject to the target platform license.

FIG. 4 shows steps of a method, in accordance with an embodiment of the invention, for isolating application source code from an incompatible target platform software license.

FIGS. 5A and 5B show steps of a method, in accordance with an embodiment of the invention, that is similar to, and more detailed than, the method shown in FIG. 4.

### DETAILED DESCRIPTION OF THE INVENTION

Before describing embodiments of the invention in more detail, a few terms will be defined. Application Programming Interface (API) refers to an interface between two software modules, programs, objects, etc. that enables one software module to access functionality provided by the other software module. A specific example of an API is the interfaces that an application program may use to access a computer's operating system to request it carry out services on its behalf. Other examples abound. Source code refers to a set of instructions, written in a programming language that is translated to object code through compilation or some other process before the program can be run on a computer. Object code, as used herein, can refer both to binary object code, sometimes referred to as native code or executable, and intermediate language code. The term “code” without further delineation is used to refer to both object code and source code.

Library refers to a file that stores related modules of object code. A library may implement in object form an API set interface definition from a corresponding header file. Stated differently, a header file may describe a set of system services provided by a library that implements, in object form, the set a system services described by the header file.

Platform is a loosely defined term for a software operating system and/or hardware, for which a third party can write software. Target platform refers to a platform for which application software is being developed and/or upon which the application software will run. Source platform refers to a platform used for developing application source code. Note that a platform can be hardware, software, or a combination of both. Also note that the source platform and target platform may reside physically on the same machine (or separate machines), even though they are separate platforms for the purposes of this invention.

Linking refers to combining several programs or modules, some of which are intended to be used together—but which were written separately—into a single program, which may be executable even though the separate programs were not themselves directly executable.

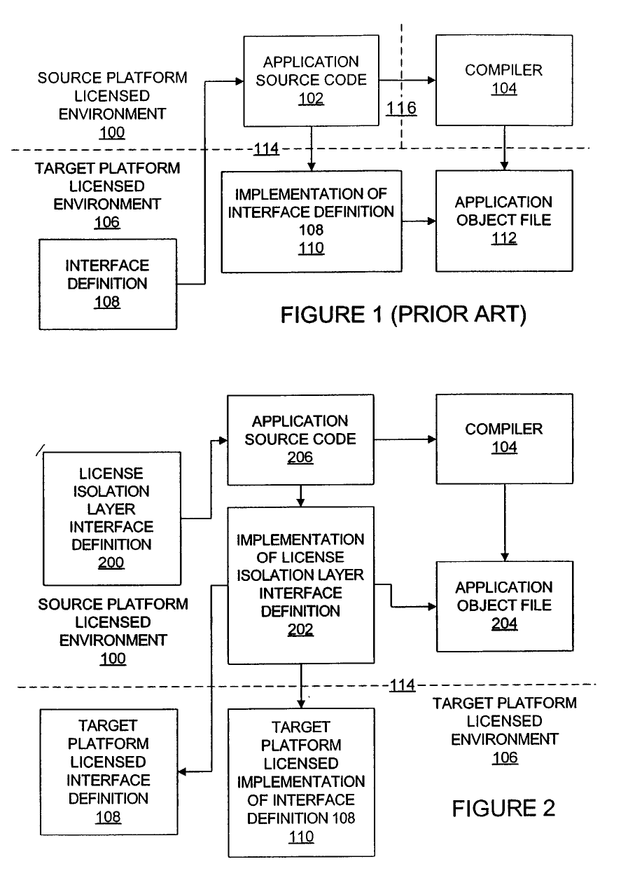

FIG. 1 depicts a prior art scenario for developing an application program to run on, and use services provided by, a target platform. Compilation of application source code 102 along with an interface definition 108 produces an application object file 112 that may be subject to the license of the interface definition 108. This type of license is also referred to in this document as a target platform license. Application object file 112 being subject to the license of the interface definition 108 could in turn result in application source code 102 having to be provided under the terms of the target platform license.

The interface definition 108 and the implementation of the interface definition 110 together depict the general scenario for various programming languages in which the interface definition 108 essentially provides a language system that tells application developers, and a compiler, how to use services provided by the implementation 110 of the interface definition 108. Interface definition 108 could be a C/C++ header file, metadata for XML, class information for Java, and the like.

The arrow from interface definition 108 to application source code 102 indicates that application source code 102 makes use of the interface definition 108. In the context of the C programming language, this could be done using an include statement. The arrow from application source code 102 to the implementation 110 of the interface definition 108 indicates that the application source code 102 binds to the implementation 110.

FIG. 1 depicts a source platform licensed environment 100 separated by dashed line 114 from a target platform licensed environment 106. Note that the developer may desire to release application source 102 or application object file 112 under different terms than the license for target platform 106. However, given the prior art method of developing application object file 112, that may not be possible. Dashed line 116 depicts that the compiler 104 may not be licensed under the source platform license or the target platform license. In subsequent figures, this detail related to licensing of the compiler is omitted to improve the clarity of the drawings.

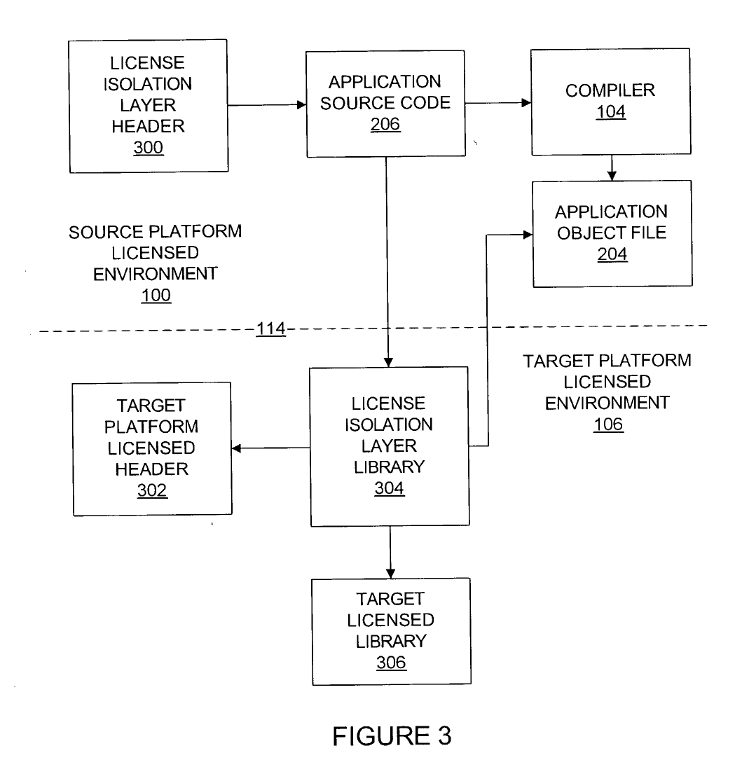

FIG. 2 depicts a example scenario for developing application source code 206 for a target platform according to the present invention. FIG. 2 includes the source platform licensed environment 100, compiler 104, target platform licensed interface definition 108, target platform licensed implementation 110 of interface definition 108, target platform licensed environment 106, and dashed line 114 as described above in connection with FIG. 1.

FIG. 2 also depicts a license isolation layer interface definition 200, an implementation 202 of license isolation layer interface definition 200, and application source code 206 in accordance with an embodiment of the invention. The license isolation layer interface definition 200 is created according to rules based on an interpretation of the target platform license in order to create an isolation layer between application source 206 and the underlying target platform implementation 110. For example, isolation layer 202 may be created in accordance with a strictest reasonable interpretation of the target platform license so that the license isolation layer interface definition 200 falls outside the scope of the target platform license.

The application object file 204 may use the implementation 202 of the license isolation layer interface definition 200 for various services. The implementation 202 of the license isolation layer interface definition 200 may use the target platform licensed interface definition 108 and may use the target platform licensed implementation 110 of the interface definition 108 for various services.

In this way, the application source code 206 may be prevented from binding directly to the target platform licensed implementation 110 of the target platform licensed interface definition 108. The application source code 206 may bind instead to the implementation 202 of the license isolation layer interface definition 200. As described in more detail below, the license isolation layer interface definition 200 or both the license isolation layer interface definition 200 and its implementation 202 may prevent the target platform license from becoming applicable to the application source code 206.

The implementation 202 may be built in accordance with a strictest reasonable interpretation of the target platform license so that the license isolation layer interface definition 200 may fall outside of the scope of the target platform license. In this way, both the application source code 206 and the source code (not shown) for the implementation 202 of the license isolation layer interface definition 200 can be isolated from the target platform license.

Even if the implementation 202 of the license isolation layer interface definition 200 falls within the scope of the target platform license, the application object file 204 and the application source code 206 can still be isolated from the target platform license as long as the license isolation layer interface definition 200 falls outside the scope of the target platform license.

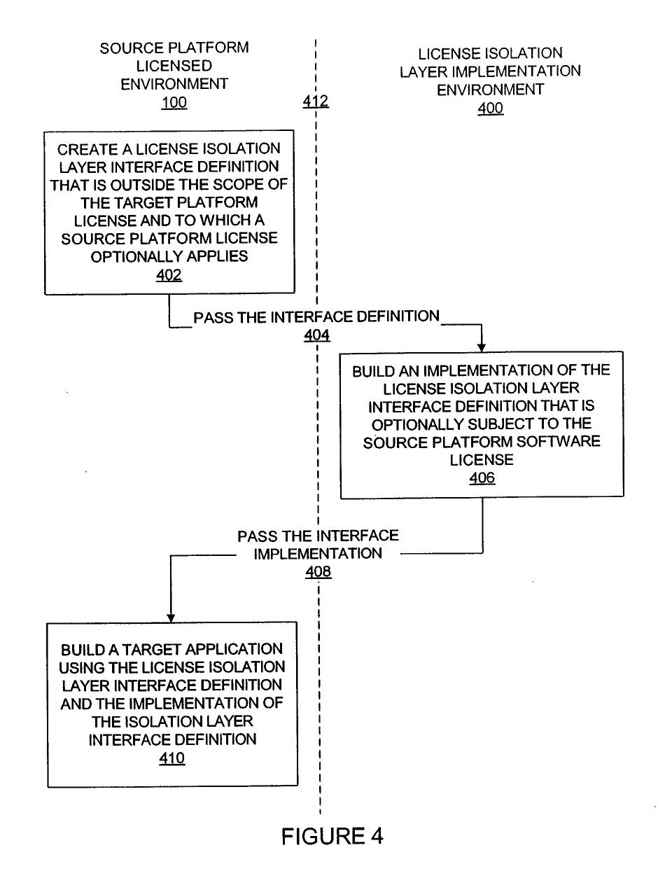

FIG. 3 shows another embodiment of the invention that is similar to the embodiment shown in FIG. 2. The license isolation layer interface definition 200 and the implementation 202 of the license isolation layer interface definition 200 are respectively replaced in FIG. 3 by a license isolation layer header 300 and a license isolation layer library 304, which is depicted in the target platform licensed environment 106.

Like the license isolation layer interface definition 200, the license isolation layer header 300 may be created in accordance with a strictest reasonable interpretation of the target platform license. Similarly, license isolation layer library 304 may be built in accordance with a strictest reasonable interpretation of the target platform license, as was discussed above in connection with the implementation 202 of the license isolation layer interface definition 200.

Although license isolation layer library 304 is shown within the target platform licensed environment 106 in FIG. 3, the license isolation layer library 304 could be isolated from the target platform license if the license isolation layer library 304 is built in accordance with a strictest reasonable interpretation of the target platform license. Regardless of whether the target platform license applies to the license isolation layer library 304, if the license isolation layer header 300 is created in accordance with a strictest reasonable interpretation of the target platform license, the license isolation layer header 300 may still prevent the target platform license from becoming applicable to the application object file 204 and the application source code 102.

The application object file 204 may use the license isolation layer library 304 for various services. The license isolation layer library 304 may use the target platform licensed header 302 and may use the target platform licensed library 306 for services. In this way, the application source code 206 may be prevented from binding directly to the target platform licensed library 306. The application source code 206 may bind instead to the license isolation layer library 304. The license isolation layer header 300 or both the license isolation layer header 300 and the license isolation layer library 304 may prevent the target platform license from becoming applicable to the application source code 206.

Isolation or adaptation layers have been used in a variety of circumstances in software engineering. In all cases, technical concerns have driven such isolation layers. For example, an adaptation layer may be created to translate calls of one form into calls accepted by an underlying platform in order to allow two otherwise incompatible programs, objects, systems, etc. to interoperate. However, the isolation layers of the present invention (such as implementation 202 and isolation library 304) are created not based on technical concerns, but based on rules and interpretations of the licenses that apply to the underlying target platform.

To further illustrate some principles of the present invention, an example will be presented using the LGPL as the underlying target platform license. This license example is selected simply because the LGPL terms are well known and it provides an adequate illustration of various principles of the invention. The principles of the invention can be applied to many other licenses and the inclusion of the example should not be used in any way to limit the scope of the invention.

In order to present the example, it is necessary to discuss certain key terms of the LGPL. The first four paragraphs of section 5 of the LGPL (Version 2.1), which are reproduced below, permit linking LGPL libraries into non-LGPL-licensed software without subjecting the non-LGPL-licensed software to the LGPL:

5. A program that contains no derivative of any portion of the Library, but is designed to work with the Library by being compiled or linked with it, is called a “work that uses the Library”. Such a work, in isolation, is not a derivative work of the Library, and therefore falls outside the scope of this License.

However, linking a “work that uses the Library” with the Library creates an executable that is a derivative of the Library (because it contains portions of the Library), rather than a “work that uses the library”. The executable is therefore covered by this License. Section 6 states terms for distribution of such executables.

When a “work that uses the Library” uses material from a header file that is part of the Library, the object code for the work may be a derivative work of the Library even though the source code is not. Whether this is true is especially significant if the work can be linked without the Library, or if the work is itself a library. The threshold for this to be true is not precisely defined by law.

If such an object file uses only numerical parameters, data structure layouts and accessors, and small macros and small inline functions (ten lines or less in length), then the use of the object file is unrestricted, regardless of whether it is legally a derivative work. (Executables containing this object code plus portions of the Library will still fall under Section 6.)

These provisions of the LGPL provide an example of a difficult line-drawing problem that certain licenses create. The LGPL provisions above try to distinguish between: (1) a work that uses the library and that is therefore not subject to the LGPL; and (2) a derivative work of the library that is subject to the LGPL. The fourth paragraph of section 5 of the LGPL essentially says that if an object files uses less than a threshold amount of implementation from an LGPL-licensed library, then the LGPL will not apply to the object file. The rationale for subjecting object files, and source code, to the LGPL when they use more than the threshold amount of an LGPL-licensed library is as follows. If an object file uses more than the threshold amount of implementation, then if the library is modified, the library vendor may need to modify the source code for the object file to get the source code and the modified library to work together properly.

Whether the LGPL will apply to application source code is significant in the context of development of closed source software for a platform in which system services, such as application programming interfaces (APIs) for accessing files and memory and the like, are contained in LGPL-licensed software. If, under the terms of the LGPL, the closed source application software is a work that uses the library, then the application source code does not have to be distributed. If the closed source application software is a derivative work of the LGPL-licensed software, however, then the closed source application software would have to be distributed under the terms of the LGPL.

Thus, it is necessary to create a set of rules from the LGPL license that can be used to create the isolation layer of the present invention. According to the description above, one approach is to identify the strictest reasonable interpretation of the license to allow for uncertainty in the terms of the license, such as are illustrated by the LGPL license above. In the case of the LGPL, the terms of the license specify that object files using “only numerical parameters, data structure layouts and accessors, and small macros and small inline functions (ten lines or less in length)” will be free from the license restrictions of the LGPL. Thus, a license isolation layer developed according to these guidelines should be free from the license terms of the LGPL.

Development of an isolation layer according to guidelines derived from the terms of the target platform license may require isolation between development groups, restricted information flow, or the like.

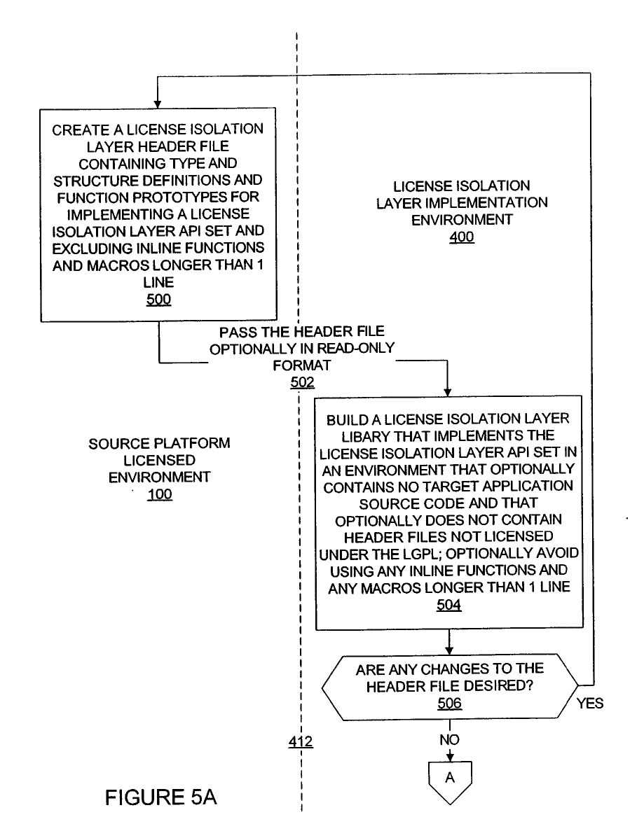

FIG. 4 depicts steps of a method in accordance with an embodiment of the invention. Dashed line 412 separates the source platform licensed environment 100 from a license isolation layer implementation environment 400, which could be consistent with either the application source code license or the target platform license. Step 402 is directed to creating a license isolation layer interface definition that is outside the scope of the target platform license and to which a source platform license optionally applies. Such an interface definition may then be passed from the source platform licensed environment 100 to the license isolation layer implementation environment 400, as shown at 404.

Step 406 is directed to building an implementation of the license isolation layer interface definition that is optionally subject to the source platform software license. Such an implementation may then be passed from the license isolation layer implementation environment 400 to the source platform licensed environment 100, as shown at 408. The implementation of the license isolation layer interface definition may make use of a target platform licensed interface definition and a target platform licensed implementation of the target platform licensed interface definition.

Step 410 is directed to building a target application using the license isolation layer interface definition and the implementation of the license isolation layer interface definition. In this way, the target application can be isolated from the target platform software license.

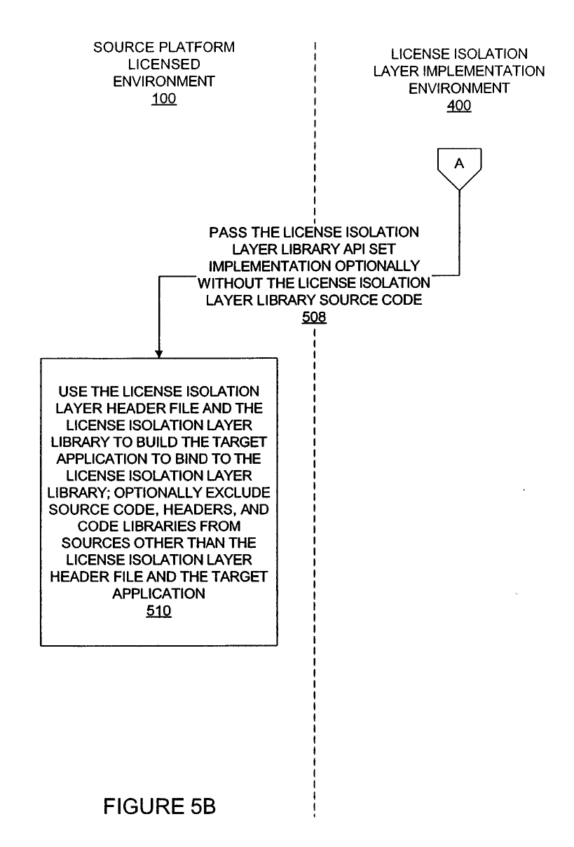

FIGS. 5A and 5B depict steps of a method in accordance with another embodiment of the invention. The steps shown in FIG. 5A and 5B are similar to, and more detailed, than the steps shown in FIG. 4. FIGS. 5A and 5B can represent an example embodiment of the invention where the LGPL applies to the underlying target platform environment.

In FIG. 5A, Step 500 is directed to creating a license isolation layer header file that contains type and structure definitions and function prototypes for implementing a license isolation layer API set. Such a header file may exclude in-line functions and macros longer than one line. The license isolation layer header file is passed, optionally in read-only format, from the source platform licensed environment 100 to the license isolation layer implementation environment 400, as shown at 502.

Step 504 is directed to building a license isolation layer library that implements the license isolation layer API set in an environment that optionally contains no target application source code and that optionally does not contain header files that are not licensed under the LGPL. In building the license isolation layer library, in-line functions and macros longer than one line may be avoided.

If any changes to the license isolation layer header file are desired, the changes may be made by returning to step 500 as indicated by the yes branch from decision step 506. Otherwise, the steps continue in FIG. 5B.

The license isolation layer library API set implementation is passed, optionally without the license isolation layer library source code, from the license isolation layer implementation environment 400 to the source platform licensed environment 100, as shown at 508. Step 510 is directed to using the license isolation layer header file and the license isolation layer library to build the target application to bind to the license isolation layer library. During this step, source code, headers, and code libraries from sources other than the license isolation layer header file and the target application may be excluded from the source platform licensed environment.

While the invention has been described with respect to specific examples including presently preferred modes of carrying out the invention, those skilled in the art will appreciate that there are numerous variations and permutations of the above described systems and methods that fall within the spirit and scope of the invention as set forth in the appended claims.

We claim:

1. A system that isolates source platform licensed application source code from a target platform software license while allowing the application source code to indirectly use target platform software, the system comprising:
a license isolation layer interface definition that is outside of the target platform software license's scope; and
an implementation of the license isolation layer interface definition that makes use of target platform software licensed components, wherein the application source code uses the license isolation layer interface definition and binds to the implementation of the license isolation layer interface definition but does not bind to target platform licensed software components.

2. The system of claim 1, wherein the license isolation layer interface definition is outside a strictest reasonable interpretation of the target platform software license's scope.

3. The system of claim 2, wherein the license isolation layer interface definition prevents the target platform software license from becoming applicable to the application source code regardless of whether the target platform software license becomes applicable to the implementation of the license isolation layer interface definition.

4. The system of claim 1, wherein the implementation of the license isolation layer interface definition is outside a strictest reasonable interpretation of the target platform software license's scope such that the implementation's source code is not subject to the target platform software license.

5. The system of claim 1, wherein
the license isolation layer interface definition is a file specified in a format readable by the compiler; and
the implementation of the license isolation layer interface definition is a license isolation library that makes use of a target platform software licensed header file and a target platform software licensed library.

6. The system of claim 5, wherein the target platform license is the lesser general public license.

7. The system of claim 5, wherein the license isolation layer header file follows a strict interpretation of the target system license, avoiding vague or ambiguous provisions.

8. The system of claim 7, wherein, except for the license isolation layer header file, the application source code does not include header files external to the application source code.

9. The system of claim 8, wherein the application source code does not link against libraries other than the license isolation layer interface library.

10. A method of isolating application source code from a target platform software license while allowing the application source code to indirectly use target platform software, the method comprising:
creating a license isolation layer interface definition that is outside the scope of the target platform license;
building an implementation of the license isolation layer interface definition that makes use of a target platform licensed interface definition and makes use of an implementation of the target platform licensed interface definition; and
building a target application using the application source code, the license isolation layer interface definition, and the implementation of the license isolation layer interface definition such that the license isolation layer interface definition isolates the application source code from the target platform software license.

11. The method of claim 10, further comprising:
passing the license isolation layer interface definition from a source platform licensed environment to a license isolation layer implementation environment;
building the implementation of the license isolation layer interface definition within the license isolation layer implementation environment; and
passing the implementation of the license isolation layer interface definition from the license isolation layer implementation environment to the source platform licensed environment.

12. The method of claim 11, further comprising: applying a source platform license, which is inconsistent with the target platform license, to the application source code.

13. The method of claim 12, further comprising: applying a source platform license, which is inconsistent with the target platform license, to the implementation of the license isolation layer interface definition.

14. A method of isolating application source code from a target platform software license while allowing the application source code to indirectly use target platform software, the method comprising:
creating a license isolation layer interface definition that is outside the scope of the target platform license, wherein the license isolation layer header file contains type and structure definitions and function prototypes for implementing a license isolation layer API set;
building a license isolation layer library that is an implementation of the license isolation layer API set, wherein the license isolation layer library makes use of a target platform licensed header file and a target platform licensed library; and
building a target application using the application source code, the license isolation layer header file, and the license isolation layer library such that the license isolation layer header file isolates the application source code from the target platform software license.

15. The method of claim 14, further comprising:
passing a read-only version of the license isolation layer header file from a source platform licensed environment to a license isolation layer implementation environment;
building the license isolation layer library within the license isolation layer implementation environment such that the license isolation layer library is outside the scope of the target platform license; and
passing the license isolation layer library from the license isolation layer implementation environment to the source platform licensed environment.

16. The method of claim 15, wherein:
the target platform license is the lesser general public license;
the license isolation layer header file does not contain any inline functions and does not contain any macros longer than 1 line; and
the license isolation layer library does not contain any inline functions and does not contain any macros longer than 1 line.

17. The method of claim 16, wherein the license isolation layer does not contain header files not licensed under the lesser general public license.

18. The method of claim 15, wherein the license isolation layer implementation environment contains no target application source code.

19. The method of claim 15, wherein the source platform licensed environment does not include source code, headers, and code libraries from sources other than the license isolation layer header file and the target application.

20. A method of generating an application object file such that application source code can indirectly use target platform software and is isolated from a target platform software license, the method comprising: compiling the application source code and a license isolation layer interface definition that is outside the scope of the target platform license to produce the application object file such that the application source code binds to an implementation of the license isolation layer interface definition, which implementation makes use of a target platform licensed interface definition and makes use of an implementation of the target platform licensed interface definition, thereby isolating the application source code from the target platform software license.
